(19) United States
(12) Patent Application Publication
(10) Pub. No.: US 2004/0150522 A1
(43) Pub. Date: Aug. 5, 2004

(54) Motion sensitive illuminated article

(76) Inventor: Damian Krause, New York, NY (US)

Correspondence Address: Marguerite Del Valle, Power Del Valle LLP, 233 West 72 Street, New York, NY, 10023, US

(21) Appl. No.: 10/355,389

(22) Filed: Jan. 31, 2003

(51) Int. Cl. G08B 13/18

(52) U.S. Cl. 340/567; 340/693.5; 362/362

(57) ABSTRACT

A device illuminated by a light controlled by a passive infrared motion detector. The light is contained within a decorative housing shaped to appear as an article of nature or a landscaping element, such as, e.g., a rock, sea shell, brick, or branch, such that the device is not discernable as a light fixture when it is not illuminated. The device can be placed along walkways or paths, and illuminates when a person passes within the effective range of the motion detector.

### BACKGROUND OF THE INVENTION

The present invention is directed to a device illuminated by a light controlled by a passive infrared motion detector. The light is contained within a decorative housing shaped to appear as an article of nature or a landscaping element, such as, e.g., a rock, sea shell, brick, or branch, such that the device is not discernable as a light fixture when it is not illuminated. The device can be placed along walkways or paths, and illuminates when a person passes within the effective range of the motion detector.

### DESCRIPTION OF RELATED ART

Control of lighting by motion detectors is known in the prior art. Typically, motion detectors are set near or along a pathway or driveway or some other outdoor area. When a person or object passes within the effective range of the motion detector, the motion detector transmits a signal to a connected light, which then causes the light to illuminate the area in which the motion was detected. Motion detectors have been used for generally security purposes, to signal when a person has entered an area and to deter the intruder, or to illuminate the area or mark a path for safe passage of those who are welcome. Motion detectors have also been used indoors as a convenience in illuminating a room, or as an energy saving device.

Previously known motion detector lighting fixtures were thus designed for security purposes or to illuminate or mark an area or path by casting light on an immediate environment or by directing light at the detected motion. Those lights, however, were visibly identifiable in the daylight or prior to illumination. This detracted somewhat from their utility as security lights, subjecting them to possible avoidance or disabling in the daylight hours when the motion detector is inactive. Where security is not the issue, for example, in an aesthetic environment where only some gentle lighting is desired, the projected light cast from security lamps limits their usefulness. This is the situation in, e.g., gardens or other quiet recreational areas, where the casting of a harsh or bright light would compromise the ambiance.

Moreover, visible lighting fixtures and motion detectors are often unwanted. In some areas, such as a garden, the mere presence of a bulky or unnatural appearing light fixture might detract from the esthetics of the place.

Efforts have been made to camouflage the motion detector portion of a light fixture. See, e.g., U.S. Pat. No. 6,346,705 to Lee, et al., which discloses a motion detector assembly for a lighting fixture that disguises the motion detector as a decorative element integrated into the design of the lighting fixture. This device would be useful, however, only where it is acceptable to use a visible, identifiable lighting fixture.

Another use of a motion detector is found in U.S. Pat. No. 6,118,375 to Duncan which discloses a portable intruder detection system for campsites. The purpose of the device disclosed therein is to provide an alarm system in a campsite. No consideration is given to the appearance or visibility of the unit or how it may blend into its surroundings.

The prior art devices typically cast light in the direction of the motion detected. The prior art does not disclose, however, a motion controlled light contained within a housing disguised as a natural or landscaping element, which illuminates the interior of the housing and which is not apparent as a light fixture when not in use.

### SUMMARY OF THE INVENTION

The present invention is directed to devices having a light within a shaped or molded housing. The device is equipped with a motion detector that provides power to the lamp when motion is detected, illuminating the housing and, depending upon the intensity of the light, the immediate environment of the device. The housing is made to resemble an article of nature or a landscaping element such as a rock, brick, branch, shell, or such outdoor fixtures as a birdhouse. If intended for indoor use, the housing may be made to appear as an interior design element, such as a vase, clock, or picture. The light can be powered by batteries or wired to an electrical system.

The device of the present invention can be used for illumination on pathways or to provide gentle directional assistance, avoiding the harsh lights of prior art motion detector security lights. The device is inconspicuous during the day as it appears as an element that is normally found in such a setting.

### BRIEF DESCRIPTION OF THE DRAWINGS

FIG. 1 is an elevational view of a device in accordance with the present invention.

FIG. 2 is a view of the FIG. 1 device having its access panel disconnected from the housing.

FIG. 3 is a perspective view of the portion of the access panel which is interior of the FIG. 1 device.

### DESCRIPTION OF THE INVENTION

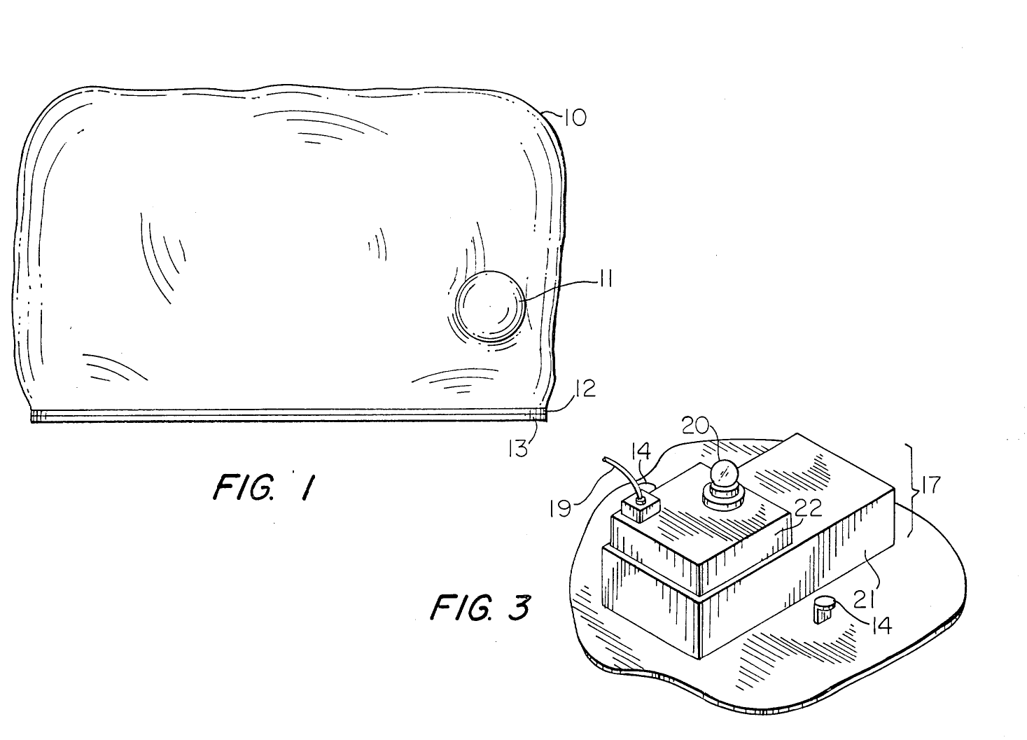

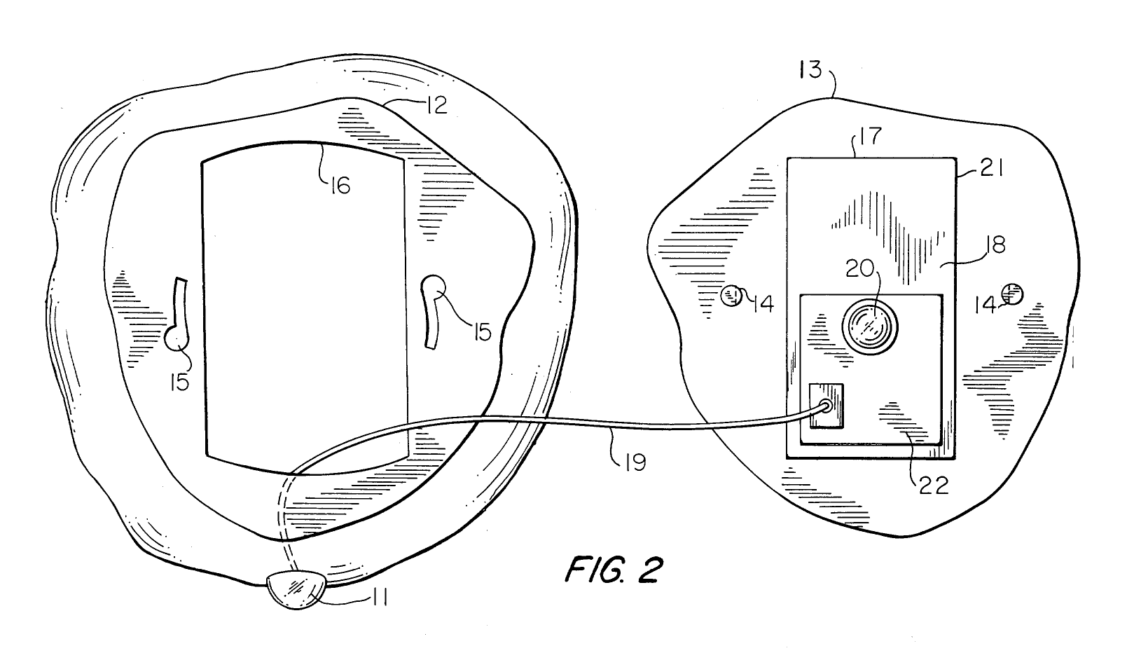

Referring to FIGS. 1-3, the components of the device of the present invention include a housing 10, shaped as a rock, having a motion detector eye 11 situated thereon. The motion detector is preferably a passive infrared device. The material used for the housing should be moldable during manufacture into various shapes, such as a rock, brick, branch, or shell, and should be translucent to the extent that a light within the housing will sufficiently illuminate the housing such as to provide a guidance or directional light to people passing near the device. Polyvinyl chloride is a suitable material for this use. In order to provide resistance to the effects of ultraviolet light exposure, a UV inhibitor such as those well known in the art, may be added to the PVC during the manufacturing process. A coating of the color and texture of the object the device is intended to imitate, creating a matte or other non-glossy surface, is preferably applied to the exterior of the housing.

The housing 10 is equipped with a base 12 to which is attached an access panel 13. Access panel 13 is removable from the base by twisting access panel 13 to disengage pins 14 from keyhole openings 15. A control module 17 is attached to the access panel 13 and is removed from the device with the access panel 13 by passage through a cut-out 16 in base 12.

Control module 17 is comprised of a power source 21, connector housing 22, and light 20. Cable 19 transmits the signal received from motion detector 11 to the connector housing 22, wherein the signal is transmitted to circuitry contained within the connector housing 22 which, by methods well known to those skilled in the art, triggers the illumination of light 20. Besides the circuitry for illuminating the light, the connector housing may contain timing circuitry for turning the light off after a set period.

I claim:

1. An apparatus comprising:
a translucent housing having the appearance of an article that is not a lighting fixture;
a light source located within the housing; and
a motion detector adapted to be coupled to a power source and to the light source for switching power to the light source when it detects motion.

2. An apparatus according to claim 1 wherein the housing appears to be an element of nature.

3. An apparatus according to claim 2 wherein the housing appears to be a rock.

4. An apparatus according to claim 1 wherein the housing appears to be a landscaping element.

5. An apparatus according to claim 1 wherein the housing appears to be an article of furniture.

6. An apparatus according to claim 1 wherein the housing appears to be an interior design element.
